(19) United States
(12) Patent Application Publication
(10) Pub. No.: US 2017/0293061 A1
(43) Pub. Date: Oct. 12, 2017

(54) LIGHT GUIDE PLATE AND LIGHT GUIDE PLATE TOOLING APPARATUS

(71) Applicant: Global Lighting Technologies Inc., Taoyuan (TW)

(72) Inventors: Chien-Chun Wu, Taoyuan (TW); Kun-Ting Liao, Taoyuan (TW); Chung-Lin Tsai, Taoyuan (TW); Jiun-Hau Ie, Taoyuan (TW)

(73) Assignee: Global Lighting Technologies Inc., Taoyuan (TW)

(21) Appl. No.: 15/479,297

(22) Filed: Apr. 5, 2017

(30) Foreign Application Priority Data
Apr. 7, 2016 (TW) 105110880

(51) Int. Cl. F21V 8/00; B29D 11/00

(52) U.S. Cl. CPC G02B 6/002; G02B 6/0065; B29D 11/00692

(57) ABSTRACT

A light guide plate for a large-size backlight module, and the light guide plate includes a light guide body and a glossy lens array. The light guide body includes a light incident surface for receiving light. The glossy lens array is formed on said light incident surface by thermal reforming a lateral terminal of said light guide body. Said glossy lens array includes a plurality of curvy ridges and the radius of curvature of each of said curvy ridges ranges from 20 μm to 50 μm, and the angle between two tilted edges of each of said curvy ridges ranges from 50 to 60 degrees, whereby said glossy lens array enables said large-size backlight module to be produced in a roll-to-roll production line without burr issue.

### CROSS-REFERENCE TO RELATED APPLICATION

This application claims the priority benefit of Taiwan application serial no. 105110880, filed on Apr. 7, 2016. The entirety of the above-mentioned patent application is hereby incorporated by reference herein and made a part of this specification.

### BACKGROUND

### Technical Field

The present disclosure generally relates to a light guide plate and a light guide plate tooling apparatus. More particularly, the present disclosure relates to a light guide plate for a large-size backlight module and the light guide plate tooling apparatus for forming a lens array of a light guide plate.

### Description of Related Art

A light guide plate is a key part of a backlight module, and the way to produce a light guide plate includes injection, embossing and extrusion. In general, a light emitting diode (LED) or a light source are arranged on the edge of the light guide plate, and the light emitted by the LED or the light source comes out uniformly from the surface of the light guide plate.

For a light guide plate to be able to provide evenly distributed light source, apart from utilizing mesh dots, named pattern, to adjust light extracting efficiency, the adjustment of light distribution around the light incident side is also an important issue. Due to the limitation on the light spreading angle of a light source, it is common to form micro structures, named lens array, in specific formations on the surface of the light incident side, so as to change the transmitting path of the light after the light enters the light guide plate, and reduce the problem of light distributing unevenly, i.e. hot spot, due to light spreading angle of the light source.

The light guide plate formed by embossing is very thin and thus can only be applied as an optical film. For instance, an embossing light guide plate, due to it lacks rigidity, is usually applied in a backlight module of a keyboard rather than a monitor. With the same reason, a lens array for the embossing light guide plate can only be made by die cut.

A conventional processing method for forming a light incident surface of a light guide plate is usually injection molding, which is molding the light guide plate while forming the micro structures on the light incident surface of the light guide plate by a mould, such that the method is advantageous in rapid production. The lens array with complicate and precise structure can only be formed by injection, such as U.S. Pat. No. 8,002,452, U.S. Pat. No. 8,491,172, U.S. Pat. No. 7,686,495, U.S. Pat. No. 7,726,864, U.S. Pat. No. 7,011,440, Foreign Pat. No. TW 1263071. The size of an injection light guide plate, due to the limitation of the injection art, is generally much smaller than the size of the light guide plate formed by other production methods. Therefore, the light guide plate formed by injection is usually applied in medium or small size monitors such as notebook and cell phone, etc.

However, with the need for the display area of a display nowadays gradually increasing, the size of the corresponding light guide plate also increases, but the molding injection technology for manufacturing the light guide plate has its own technical limitations and is unable to directly produce a large-size light guide plate. Therefore, a method of firstly forming a light guide plate by extrusion and then cutting out the micro structures on the light incident surface by a blade is developed by the industry. Even though a Computer Numerical Control (CNC) apparatus is capable of processing the light incident surface of the large-size light guide plate, significantly amount of grains and dust produced from the cutting process is inevitable. The grains and dust are left on the light guide plate after the micro structures are formed, such that the quality of the light guide plate is seriously affected.

In addition, another method of attaching a light incident structure layer is also adopted to form a light incident structure on the light incident surface. However, this method is even more inconvenient for manufacture, and as long as there is some structural inconformity, it would leave significantly impact on light adjustment.

The cited references of the prior art are listed below and considered irrelevant: U.S. Pat. No. 7,681,347 discloses a light guide plate with lens array made by injection for lighting, Foreign application No. TW 201202800 discloses a laser process for making the pattern, Foreign application No. TW 200809135 discloses a groove structure for enhancing the optical orthogonal output.

### SUMMARY

Accordingly, the present disclosure is directed to a light guide plate for a large-size backlight module, which is capable of achieve rapid production and the lens array thereof is formed in a precise manner.

The present disclosure is further directed to the light guide plate tooling apparatus, which is capable of achieve rapid production in forming a glossy lens array of a light guide plate and the glossy lens array is formed in a precise manner.

The present disclosure provides a light guide plate for a large-size backlight module, and the light guide plate includes a light guide body and a glossy lens array. The light guide body includes a light incident surface for receiving light. The glossy lens array is formed on said light incident surface by thermal reforming a lateral terminal of said light guide body. Said glossy lens array includes a plurality of curvy ridges and the radius of curvature of each of said curvy ridges ranges from 20 μm to 50 μm, and the angle between two tilted edges of each of said curvy ridges ranges from 50 to 60 degrees, whereby said glossy lens array enables said large-size backlight module to be produced in a roll-to-roll production line without burr issue.

The present disclosure provides a light guide plate tooling apparatus for forming the glossy lens array of the light guide plate. The light guide plate tooling apparatus includes a tooling body being in a cylindrical shape and a plurality of embossing ribs. The embossing ribs are disposed on a processing region of said tooling body, and a long axis of each of said embossing ribs being parallel to a center axis of said tooling body, so that a cross section of said processing region is in a gear-like shape, said embossing ribs are configured for heating said light incident surface and thermal imprinting a plurality of light-spreading micro structures on said light incident surface.

According to an embodiment of the present disclosure, wherein the light guide plate further includes a plurality of curvy grooves, said curvy grooves and said curvy ridges are arranged alternately to form said glossy lens array, and the radius of curvature of each of said curvy grooves ranges from 20 μm to 40 μm.

According to an embodiment of the present disclosure, each of said curvy ridges is formed by accumulating two molten materials of adjacent two of said curvy grooves.

According to an embodiment of the present disclosure, the radian of each of the said curvy grooves and said curvy ridges is 1 π rad.

According to an embodiment of the present disclosure, the length of a short axis of said light incident surface ranges from 1 mm to 3 mm.

According to an embodiment of the present disclosure, the light guide plate further includes a plurality of curvy grooves, said curvy grooves and said curvy ridges are arranged alternately to form said glossy lens array, and a width of each of said curvy grooves being less than 2 μm.

According to an embodiment of the present disclosure, a depth of each of said curvy ridges ranges from 0.03 mm to 0.04 mm.

According to an embodiment of the present disclosure, the distances between any adjacent two of said curvy ridges ranges from 0.065 mm to 0.075 mm.

According to an embodiment of the present disclosure, the light guide plate tooling apparatus further includes a material discharging region connected to two sides of said processing region.

According to an embodiment of the present disclosure, a short-axis length of said light incident surface ranges from 1 mm to 3 mm.

According to an embodiment of the present disclosure, each of said material extruding region includes an extension portion protruded from said light incident surface.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic view of a light guide plate according to an exemplary embodiment.

FIG. 2 illustrates a schematic view of a light incident surface of a light guide plate according to an exemplary embodiment.

FIG. 3 illustrates a scenario of forming a glossy lens array of a light guide plate by a light guide plate tooling apparatus according to an exemplary embodiment.

FIG. 4 illustrates a scenario of forming a glossy lens array of a light guide plate by a light guide plate tooling apparatus according to another exemplary embodiment.

FIG. 5 illustrates a scenario of forming a glossy lens array of a light guide plate according to an exemplary embodiment.

FIG. 6 and FIG. 7 illustrate a manufacturing process of a glossy lens array of a light guide plate according to an exemplary embodiment.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

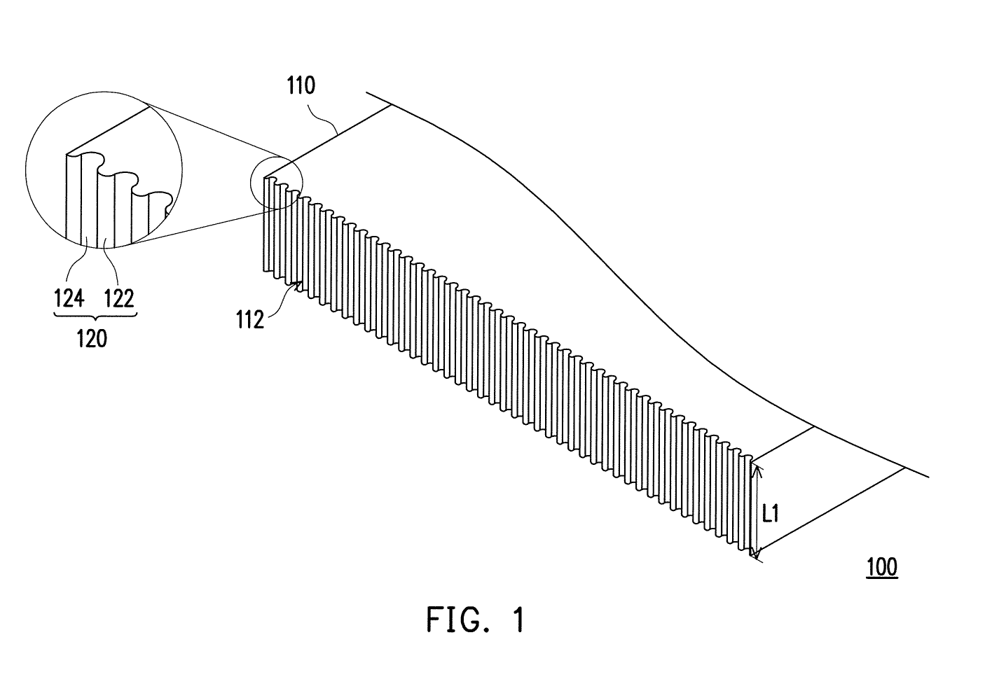

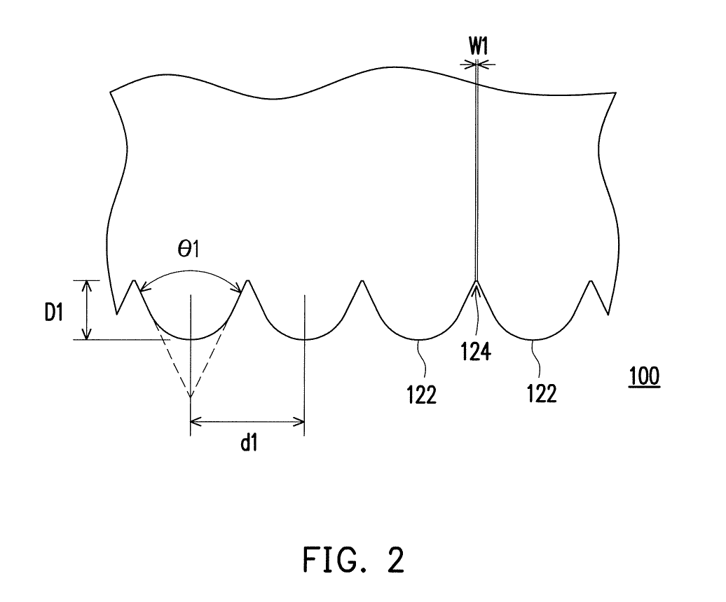

FIG. 1 illustrates a schematic view of a light guide plate according to an exemplary embodiment. FIG. 2 illustrates a schematic view of a light incident surface of a light guide plate according to an exemplary embodiment. Referring to FIG. 1 and FIG. 2, in the present embodiment, a light guide plate 100 is applicable to a large-size backlight module, and the size of the large-size backlight module may be, for example, equal to or larger than 55 inches. Certainly, the disclosure is not limited thereto. The light guide plate 100 includes a light guide body 110 and a glossy lens array 120. The light guide body 110 includes a light incident surface 112 for receiving light. In the present embodiment, the length L1 of a short axis of the light incident surface 112 may range from 1 mm to 3 mm. The glossy lens array 120 is formed on the light incident surface 112 by thermal reforming a lateral terminal of the light guide body 110. Namely, the glossy lens array 120 is formed on the light incident surface 112 by heating and reforming the light incident surface 112. Thereby, the glossy lens array 120 formed on the light incident surface 112 is capable of changing the transmitting path of the light entering the light guide plate 100, such that the light may be spread evenly in the light guide plate 100, so as to reduce the problem of hot spot due to light spreading angle of the light source.

In the present embodiment, the glossy lens array 120 includes a plurality of curvy ridges 122 as shown in FIG. 2. For example, the radius of curvature R1 of each curvy ridge 122 may range from 20 μm to 50 μm, and the angle θ₁ between two tilted edges of each curvy ridge 122 may range from 50 to 60 degrees. In the present embodiment, the light guide plate 100 may further include a plurality of curvy grooves 124, and the curvy grooves 124 and the curvy ridges 122 are arranged alternately to form the glossy lens array 120, and the a width W1 of each curvy groove 124 may be less than 2 μm. In detail, the depth D1 of each of the curvy ridges 122 may range from 0.03 mm to 0.04 mm. The distance dl between any adjacent two of the curvy ridges 122 may range from 0.065 mm to 0.075 mm.

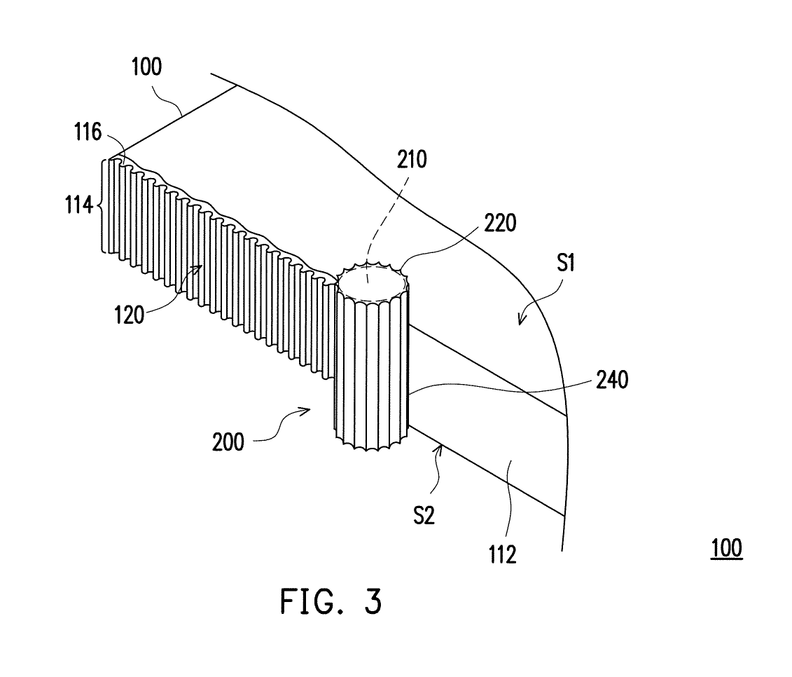

FIG. 3 illustrates a scenario of forming a glossy lens array of a light guide plate by a light guide plate tooling apparatus according to an exemplary embodiment. In the present embodiment, the glossy lens array 120 of the light guide plate 100 as shown in FIG. 2 may be formed by a light guide plate tooling apparatus 200 as shown in FIG. 3. The light guide plate tooling apparatus 200 includes a tooling body 210 being in a cylindrical shape and a plurality of embossing ribs 220. The embossing ribs 220 are disposed on a processing region 240 of said tooling body 210. A long axis of each embossing rib 220 is parallel to a center axis of the tooling body 210, so that a cross section of the processing region 240 is in a gear-like shape. Accordingly, the embossing ribs 220 are configured for heating the light incident surface 112 and thermal imprinting a plurality of light-spreading micro structures (e.g. the glossy lens array 120) on the light incident surface 112. In the present embodiment, the embossing ribs 220 are configured for thermal imprinting a plurality of curvy grooves 124 which define the curvy ridges 122, so as to form the glossy lens array 120 on the light incident surface 112. Thereby, the formation of the glossy lens array 120 enables the large-size backlight module to be produced in a roll-to-roll production line without burr issue.

In the present embodiment, the shape of the cross section of the processing region 240 may be adjusted according to the requirement of the glossy lens array 120. For example, when types and/or strength of the light sources configured on the light guide plate 100 are different, the formation of the corresponding glossy lens array 120 may change accordingly. For example, the glossy lens array 120 may be in a wave or a saw tooth manner. Therefore, the cross section of the processing region 240 may also change according to different formations of the glossy lens array 120, so as to thermally imprint the desired glossy lens array 120.

In the present embodiment, the light guide plate tooling apparatus 200 are configured for heating the light incident surface 112 and thermal imprinting the glossy lens array 120 on the light incident surface 112 by rolling along a long axis of the light incident surface 112. Accordingly, after being processed by the light guide plate tooling apparatus 200, the light incident surface 112 includes a light spreading region 114 and a material extruding region 116 as shown in FIG. 3. The glossy lens array 120 is formed on the light spreading region 114.

In detail, the light spreading region 114 is the corresponding operation region when the light sources are configured onto the light guide plate 100. The material extruding region 116 is the region where the produced residuum gathers after the light incident surface 112 is thermally imprinted to from the glossy lens array 120. In the present embodiment, the residuum may extend along a first surface S1 and a second surface S2, which are perpendicular and connected to the light incident surface 112, so as to gather and cool down in the material extruding region 116. Therefore, by utilizing the light guide plate tooling apparatus 200, the glossy lens array 120 may be formed on the light incident surface 112 rapidly, so as to significantly increase the production efficiency of the glossy lens array 120 and also maintain the structural precision of the glossy lens array 120.

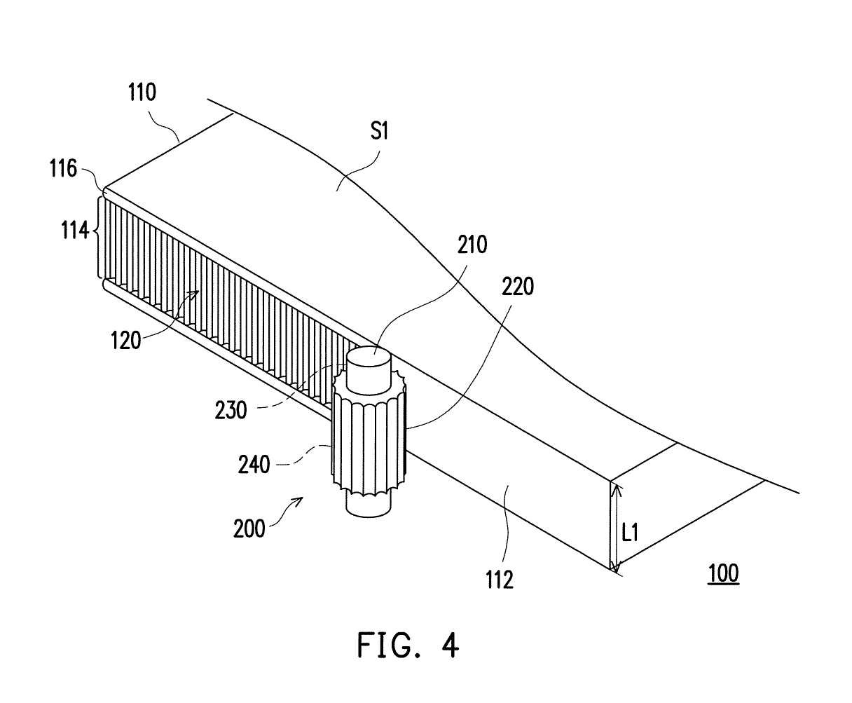

FIG. 4 illustrates a scenario of forming a glossy lens array of a light guide plate by a light guide plate tooling apparatus according to another exemplary embodiment. Referring to FIG. 4, in the present embodiment the light guide plate tooling apparatus 200 may include the processing region 240 and a material discharging region 230. The material discharging region 230 is connected to two sides of the processing region 240. The embossing ribs 220 are disposed within the processing region 240. Accordingly, in the light guide plate 100 processed by the light guide plate tooling apparatus 200, a sum of a short-axis length of the light spreading region 114 and a short-axis length of the material extruding region 116 is equal to or smaller than a short-axis length L1 of the light incident surface 112.

When forming the glossy lens array 120 on the light incident surface 112, the embossing ribs 220 in the processing region 240 contacts and imprints the light incident surface 112, such that the glossy lens array 120 is formed on the light spreading region 114 of the light incident surface 112, and the residuum, which is generated from the light incident surface 112 being thermally imprinted by the embossing ribs 220, may be gathered to the reserved space, so as to form an extension portion on the material extruding region 116, and the extension portion is protruded from the light incident surface 112. As such, the extension portion of the material extruding region 116 is protruded along a direction substantially perpendicular to the light incident surface 112, and may not be extended to the first surface S1 and the second surface S2, so the maximum thickness would not increase after forming the glossy lens array 120. Therefore, the light guide plates 100 processed by the light guide plate tooling apparatus 200 may be stacked up tightly and smoothly without being affected by the cooled residuum, so as to facilitate the subsequent mass production and dispatching manners. It is noted that the light guide plate tooling apparatus 200 including one processing region 240 and two material discharging regions 230 is illustrated in the present embodiment, but the numbers and the formations of the processing region 240 and the material discharging region 230 may still be adjusted according to the required distribution manner of the glossy lens array 120.

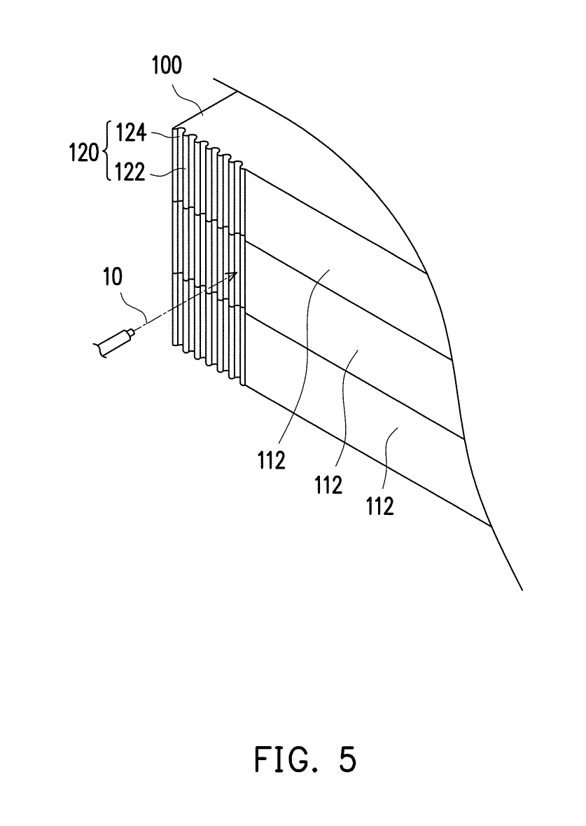

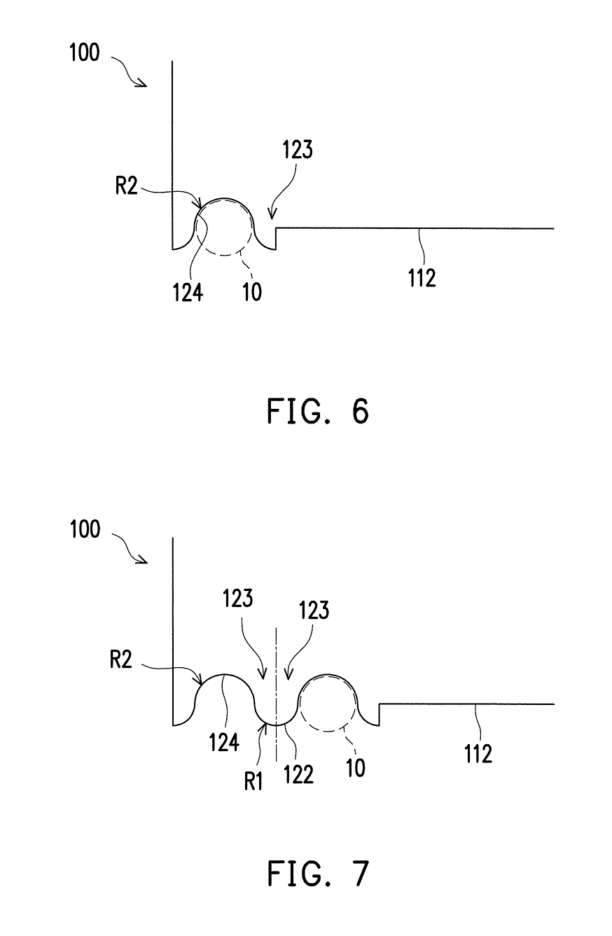

FIG. 5 illustrates a scenario of forming a glossy lens array of a light guide plate according to an exemplary embodiment. FIG. 6 and FIG. 7 illustrate a manufacturing process of a glossy lens array of a light guide plate according to an exemplary embodiment. Referring to FIG. 5 to FIG. 7, in the present embodiment, the glossy lens array 120 of the light guide plate 100 may be formed by another thermal reform process such as laser melting process to form the curvy ridges 122 and a plurality of curvy grooves 124 on the light incident surface 112. The curvy grooves 124 and the curvy ridges 122 are arranged alternately to form the glossy lens array 120 as shown in FIG. 7, and the radius of curvature R2 of each curvy groove 124 may range from 20 μm to 40 μm.

In the present embodiment, when a laser beam 10 bombards the light incident surface 112, one of the curvy grooves 124 is formed as shown in FIG. 6, and the molten material 123 generated from the light guide plate 100 due to high temperature of laser. Then, the laser beam 10 shifts in parallel and bombards the light incident surface 112 again to form another curvy groove 124, and two molten materials 123 generated by the formation of the two adjacent curvy grooves 124 is accumulated to form the curvy ridge 122. Namely, the curvy ridge 122 is formed by accumulating two molten materials 123 of adjacent two of said curvy grooves 124. Then, the steps described above may be repeatedly perform until the glossy lens array 120 is formed. In one embodiment, the radius of curvature R2 of each curvy groove 124 may range from 35 μm to 50 μm, and the radius of curvature R1 of each curvy ridge 122 may range from 25 μm to 40 μm. Accordingly, the radian of each of the said curvy grooves and said curvy ridges is 1 π rad.

In brief, by utilizing the laser with the conditions capable of forming the curvy groove 124 with the radius of curvature R2 ranges from 35 μm to 50 μm and the curvy ridge 122 with the radius of curvature R1 ranges from 25 μm to 40 μm to perform multiple laser bombardments with parallel shifting after each bombardment, the curvy grooves 124 may be formed by the laser bombardments and the molten materials 123 generated due to the laser bombardments may be accumulated between two adjacent curvy grooves 124 to form the curvy ridges 122, so as to form the glossy lens array 120 with the curvy grooves 124 and the curvy ridges 122 arranged alternately as shown in FIG. 5 and FIG. 7. Thereby, the formation of the glossy lens array 120 enables the large-size backlight module to be produced in a roll-to-roll production line without burr issue. In the present embodiment, multiple light guide plates 100 may firstly stacked on top of one another, and the light incident surfaces 112 of the light guide plates 100 are aligned with one another. Thereby, the laser beam 10 may bombard the light incident surfaces 112 of the light guide plates 100 all together to perform mass production. In other embodiment, the laser beam 10 may also bombard one light guide plate 100 at a time. The disclosure is not limited thereto.

In sum, the light guide plate and the light guide plate tooling apparatus of present disclosure utilize the thermal reforming process to form the glossy lens array on the light incident surface, so as to eliminate hot spots result from light sources integrated to the light guide plate and the light emitted from the light guide plate may be more uniform. For a large-size light guide plate applicable to a large-size backlight module especially, by utilizing the processing method and the light guide plate tooling apparatus of the disclosure, not only mass production efficiency of the light guide plate may be effectively enhanced but the quality and yield of the light guide plate also maintains.

Based on the above discussions, it can be seen that the present disclosure offers various advantages. It is understood, however, that not all advantages are necessarily discussed herein, and other embodiments may offer different advantages, and that no particular advantage is required for all embodiments.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A light guide plate for a large-size backlight module, comprising:
a light guide body comprising a light incident surface for receiving light; and
a glossy lens array formed on said light incident surface by thermal reforming a lateral terminal of said light guide body, said glossy lens array comprising a plurality of curvy ridges, the radius of curvature of each of said curvy ridges ranges from 20 μm to 50 μm, and the angle between two tilted edges of each of said curvy ridges ranges from 50 to 60 degrees,
whereby said glossy lens array enables said large-size backlight module to be produced in a roll-to-roll production line without burr issue.

2. The light guide plate for the large-size backlight module of claim 1, further comprising a plurality of curvy grooves, said curvy grooves and said curvy ridges are arranged alternately to form said glossy lens array, and the radius of curvature of each of said curvy grooves ranges from 20 μm to 40 μm.

3. The light guide plate for the large-size backlight module of claim 2, wherein each of said curvy ridges is formed by accumulating two molten materials of adjacent two of said curvy grooves.

4. The light guide plate for the large-size backlight module of claim 3, wherein the radian of each of the said curvy grooves and said curvy ridges is 1 π rad.

5. The light guide plate for the large-size backlight module of claim 3, wherein a short-axis length of said light incident surface ranges from 1 mm to 3 mm.

6. The light guide plate for the large-size backlight module of claim 1, further comprising a plurality of curvy grooves, said curvy grooves and said curvy ridges are arranged alternately to form said glossy lens array, and a width of each of said curvy grooves being less than 2 μm.

7. The light guide plate for the large-size backlight module of claim 6, wherein a depth of each of said curvy ridges ranges from 0.03 mm to 0.04 mm.

8. The light guide plate for the large-size backlight module of claim 6, wherein the distances between any adjacent two of said curvy ridges ranges from 0.065 mm to 0.075 mm.

9. A light guide plate tooling apparatus for forming the glossy lens array of the light guide plate of claim 6, comprising:
a tooling body being in a cylindrical shape; and
a plurality of embossing ribs disposed on a processing region of said tooling body, and a long axis of each of said embossing ribs being parallel to a center axis of said tooling body, so that a cross section of said processing region is in a gear-like shape, said embossing ribs are configured for heating said light incident surface and thermal imprinting a plurality of light-spreading micro structures on said light incident surface.

10. The light guide plate tooling apparatus of claim 9, further comprising a material discharging region connected to two sides of said processing region.

11. The light guide plate tooling apparatus of claim 9, wherein a short-axis length of said light incident surface ranges from 1 mm to 3 mm.

12. The light guide plate tooling apparatus of claim 9, wherein said light incident surface comprises a light spreading region and a material extruding region, said glossy lens array is formed on said light spreading region and said material extruding region comprises an extension portion protruded from said light incident surface.
